(19) United States
(12) Patent Application Publication
(10) Pub. No.: US 2025/0347353 A1
(43) Pub. Date: Nov. 13, 2025

(54) ADAPTER APPARATUS FOR CONVERTING A VALVE

(71) Applicants: Robert Pescatore, JR., Chandler, AZ (US); Robert Pescatore, SR., Scottsdale, AZ (US)

(72) Inventors: Robert Pescatore, JR., Chandler, AZ (US); Robert Pescatore, SR., Scottsdale, AZ (US)

(21) Appl. No.: 19/205,758

(22) Filed: May 12, 2025

Related U.S. Application Data
(60) Provisional application No. 63/646,223, filed on May 13, 2024.

(51) Int. Cl. F16K 31/05

(52) U.S. Cl. CPC F16K 31/055

(57) ABSTRACT

A valve adaptor apparatus designed to convert a manual valve to automatic operation. The apparatus comprises a valve adapter with a top and bottom surface and at least one hole extending from the top to the bottom surface, an actuator, and a valve actuator adapter. The actuator is electronically controlled and adjusts the valve settings based on external commands. The valve adapter is designed to engage with the manual valve.

### CROSS-REFERENCE TO RELATED APPLICATIONS

This application claims benefit from currently pending U.S. Provisional Application No. 63/646,223 titled “Adapter Apparatus for Converting a Valve” and having a filing date of May 13, 2024, all of which is incorporated by reference herein.

### FIELD OF THE INVENTION

The technology relates to the field of automated valve control systems, specifically focusing on devices engineered to convert manual operation valves into automated ones with minimal infrastructure modification. This technology is particularly designed for implementation with existing valve models prevalent in residential water systems, emphasizing ease of installation and enhanced system control through remote operations.

### BACKGROUND OF THE INVENTION

Valves are critical components in the control of fluid flow within various systems, serving pivotal roles in residential and commercial plumbing. Traditionally, these valves, including check valves, ball valves, and gate valves, have required manual operation, necessitating physical intervention to either open or close the valve to control the flow of fluids. While manual operation has been reliable in achieving basic flow control, it lacks the capacity for remote operation and fails to integrate with contemporary smart home technology, which manages a variety of other domestic utilities, enhancing user convenience and system efficiency.

To address these limitations, the field has seen developments in motorized valve actuators that can be retrofitted onto traditional manual valves. These motorized systems are designed to interface with automated home systems or control panels, enabling automated adjustment of valve positions in response to commands from the control system. However, these solutions often require significant modifications to existing plumbing systems or expect users to possess specialized knowledge to install and operate the systems, thus limiting their accessibility and usability for the average consumer. Moreover, previous implementations have skewed towards industrial applications, overlooking the specific needs and preferences of residential use—principally the demands for simplicity, ease of use, and integration with other home automation systems.

Furthermore, most existing automated valve systems necessitate a continuous power supply and professional installation, posing substantial barriers for homeowners looking to adopt smarter technologies. These systems are typically comprehensive and complex, leading to higher costs and more involved installation procedures, which are often disproportionate to the needs of residential environments where simpler, more direct solutions are favored. Manual valves such as the Clack V3006, Fleck Plastic Bypass valve, and CS-BYPASS are widely used for controlling the flow of fluids. These valves typically require manual operation, which can be labor-intensive and less precise compared to automated systems. The manual operation of these valves involves turning a valve stem, which can be inconvenient or challenging in certain situations or environments.

The market demonstrates a significant demand for a system that can easily convert manual valves to automated operation, compatible with a variety of residential valve types without requiring the full replacement of existing fixtures. Ideal solutions would support seamless integration with the Internet of Things (IoT), facilitating advanced monitoring and control capabilities via familiar smart devices. This need extends to emergency management features such as rapid shut-off in the event of leaks or pipe bursts, underscoring the importance of compatibility with household monitoring systems without the high costs or complex installations associated with current full-scale automation systems.

Therefore, there is a need for an adaptable, easy-to-install device that can convert widely used manual valve models into intelligent components that are controllable via modern technologies such as smartphone applications and home automation systems. This device should offer options for both AC and battery-powered operations, enhancing flexibility and installation ease while providing reliability through power backup options and automated notifications for enhanced safety and operational assurance. Such innovations would meet consumer expectations for functionality, affordability, and simplicity, thereby filling the existing gap in the technology market and fostering wider adoption of home automation solutions.

### BRIEF SUMMARY OF THE INVENTION

The present invention provides among other things an apparatus designed to convert a manual valve to automatic operation. More specifically, this apparatus comprises an adapter, an electronically controlled actuator, and a control unit. The adapter is configured to engage with an existing valve and includes a top surface, a bottom surface, and specifically configured holes that facilitate connection with the actuator and engagement with the valve. The apparatus comprises a valve adapter with a top and bottom surface and at least one hole extending from the top to the bottom surface. The hole includes a stopping member configured to engage with the manual valve. The apparatus can also include an actuator and a valve actuator adapter. The actuator can be coupled to the valve adapter and the valve actuator adapter is coupled to the actuator and rotatably coupled to the valve adapter. The actuator adjusts the valve settings based on external commands.

The valve adaptor apparatus includes an extension member protruding from the top surface of the valve adapter. The extension member comprises a guide hole and an actuator hole that couples the actuator to the extension. The valve actuator adapter can be rotatably coupled to the guide hole. The valve adaptor apparatus includes an electronically controlled actuator. The valve adapter is made from material plastics and/or metals. The apparatus can further include a control unit operatively connected to the actuator to facilitate adjustment of valve settings. Sensors can be integrated into the actuator and configured to detect the current position of the valve. A motor unit within the actuator provides the torque necessary for adjusting the valve.

In a further aspect, the control unit can be programmed to receive commands from a smart device application and is connected through IoT communication protocols. The adapter can be powered by a power source from either a direct electrical connection or battery power. The apparatus also includes safety mechanisms configured to activate automatic water shutoff upon detection of leaks within the system. The apparatus is configured to maintain a predefined state during power outages or mechanical failures and to transmit notifications regarding the system's status to the user through the smart device application.

Overall, these aspects collectively provide a sophisticated, reliable, and user-friendly solution for converting manual valves to automated operation, thereby enhancing functionality and ensuring safety in residential water systems.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 shows an exploded isometric view of an automatic valve adapting system in accordance to one or more embodiments;

FIG. 2 shows an exploded front view of an automatic valve adapting system in accordance to one or more embodiments;

FIG. 3a shows an exploded side view of an automatic valve adapting system in accordance to one or more embodiments;

FIG. 3b shows a cross-sectional view of FIG. 3a of an automatic valve adapting system in accordance to one or more embodiments;

FIG. 4 shows a top view of an automatic valve adapting system in accordance to one or more embodiments;

FIG. 5 shows a bottom view of an automatic valve adapting system in accordance to one or more embodiments;

FIG. 6 shows an exploded isometric view of another embodiment of an automatic valve adapting system in accordance to one or more embodiments; and

FIG. 7 shows yet another embodiment of an single automatic valve adapting system in accordance to one or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

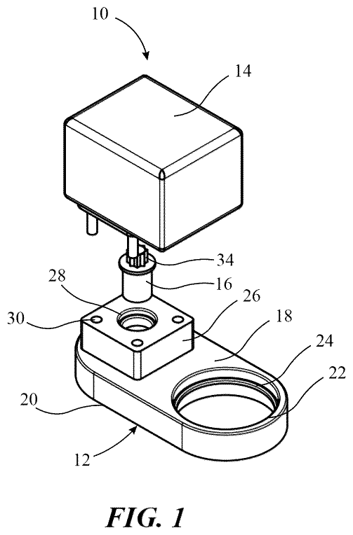

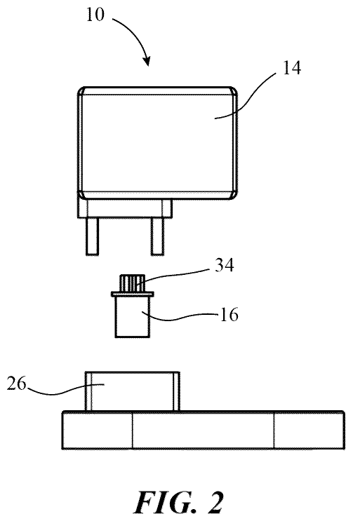

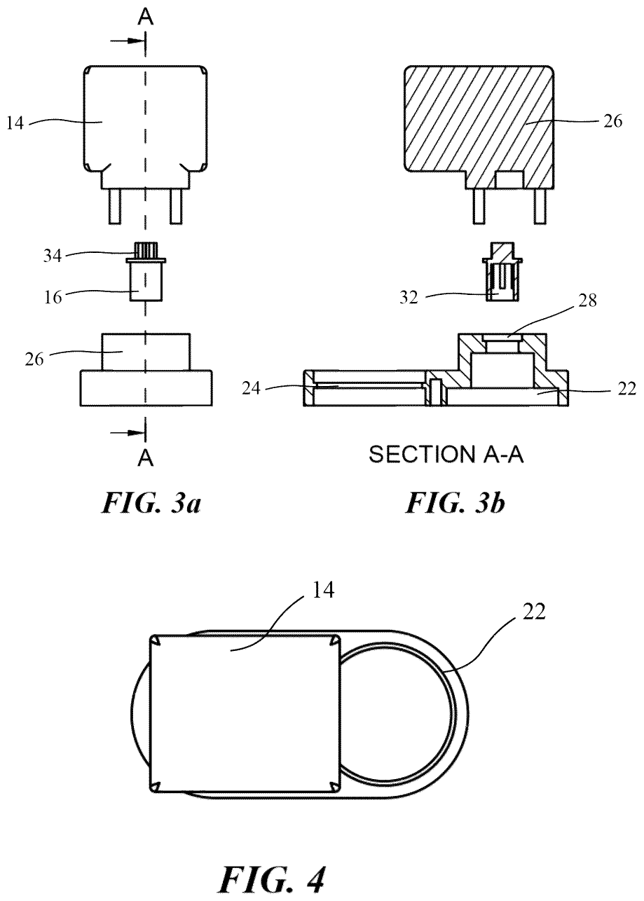

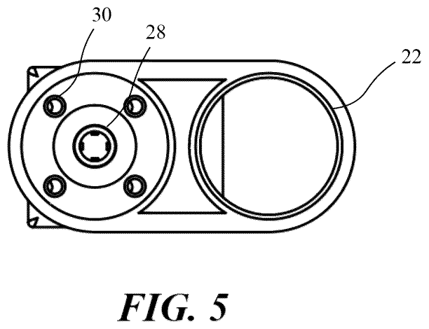

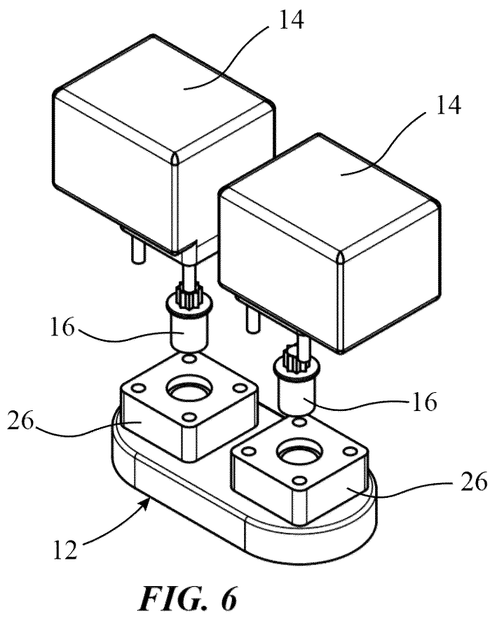

Referring to FIGS. 1-5, the figure shows an automatic valve adapting system for converting a manual valve having a valve stem extending from a valve body to automatic operation shown generally at 10. The apparatus 10 can comprise a valve adapter 12, an actuator 14, and a valve actuator adapter 16.

The valve adapter 12 has a top surface 18 and a bottom surface 20 and at least one hole 22 extending from the top surface to the bottom surface. The at least one hole 22 has a stopping member 24 configured to engage with the valve body. The actuator 14 can be coupled to the valve adapter 12 and the valve actuator adapter 16 can be coupled to the actuator and rotatably coupled to the valve adapter. The valve actuator adapter 16 is configured to interact with the valve stem of the stock valve such that rotation of the valve actuator adapter 16 rotates the valve stem. The actuator 14 can adjust the valve settings by rotating the valve stem based on external commands.

The at least one hole 22 can be such as, for example, one hole, two holes, three holes, four holes, or the like to adapt to manual valves with multiple valves. The at least one hole 22 can be any suitable shape and size diameter to fit around a manual valve. In specific embodiments, the hole 22 may be circular, hexagonal, square, rectangular, or custom-shaped to accommodate different valve body geometries. The diameter or dimensions of the hole 22 may range from approximately 0.5 inches to 4 inches, depending on the specific valve model being adapted.

In particular embodiments, the hole configurations are specifically designed to accommodate industry-standard valves including but not limited to the Clack V3006 valve, Fleck Plastic Bypass valve, and CS-BYPASS valve. The hole 22 may include tapered edges or internal ridges to facilitate alignment with the valve body during installation.

The at least one hole 22 in the valve adapter 12 can be configured to engage with the valve body. This configuration allows for a secure and stable connection between the valve adapter 12 and the manual valve, ensuring that the valve adapter can effectively convert the manual valve to automatic operation.

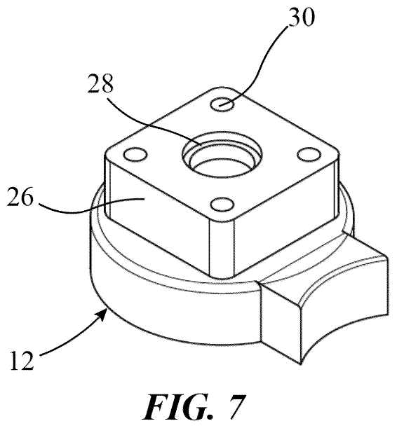

The top surface 18 of the valve adapter 12 can have at least one extension member 26 protruding from the top surface and positioned over the at least one hole 22. In certain embodiments, the at least one protrusion can be such as, for example, one protrusion, as shown in FIG. 7, at least two protrusions, as shown in FIG. 6, three protrusion, four protrusions, or the like positioned over the at least one holes 22.

The extension member 26 can comprise a guide hole 28 wherein the guide hole can be positioned over the at least one hole 22 wherein the guide hole and at least one hole complete a hole from the top surface 18 to the bottom surface 20. The extension member 26 may have a height ranging from approximately 0.5 inches to 3 inches, depending on the specific valve model and the required clearance for the actuator 14.

The extension member 26 may be formed integrally with the valve adapter 12 or may be attached separately using fasteners, adhesives, or other joining methods. In alternative embodiments, the extension member 26 may be adjustable in height to accommodate various valve stem lengths. This adjustment may be achieved through telescoping sections, stackable components, or threaded adjustment mechanisms.

In embodiments, the stopping member 24 of the at least one hole 22 can be a smaller diameter than the at least one hole and can allow for the manual valve stem and the valve actuator adapter 16 to pass through the at least one hole 22 so that the valve actuator adapter 16 can interact with the valve stem. The stopping member 24 can be any suitable shape and size and can come into contact with the manual valve stopping the valve adapter 12 from being positioned further down the manual valve.

The stopping member 24 can be one piece around the inner diameter of the at least one hole 22 or it can be multiple pieces positioned evenly or unevenly around the inner diameter of the at least one hole. The stopping member 24 may be formed from the same material as the valve adapter 12 or may be formed from a different material with specific friction or cushioning properties. In some embodiments, the stopping member 24 may include a flexible or semi-flexible material such as rubber, silicone, or other elastomers to provide a secure and water-tight seal against the valve body. The stopping member 24 may also include ridges, grooves, or other textured surfaces to enhance grip on the valve body.

In embodiments, the valve actuator adapter 16 can be rotatably coupled to the guide hole 28 wherein the valve actuator adapter can rotate freely within the guide hole allowing the actuator 14 to rotate the valve stem. This configuration allows for the valve actuator adapter 16 to rotate in relation to the valve adapter 12, providing the necessary movement for the actuator to adjust the valve settings.

The guide hole 28 can allow for the valve actuator adapter 16 to loosely fit within the hole and allow the valve actuator adapter to rotate freely within the guide hole. In certain embodiments, the valve actuator adapter 16 can have an adapter hole 32 on one side configured to accept an end of the valve stem into the adapter hole 32 and gear teeth 34 on the other side allowing the gear teeth to couple with the actuator 14.

The adapter hole 32 may be available in various shapes and sizes to accommodate different valve stem configurations. These may include, but are not limited to, square, hexagonal, D-shaped, or star-shaped configurations that match common valve stem designs. In some embodiments, the adapter hole 32 may include interchangeable inserts to accommodate different valve stem shapes without requiring a complete replacement of the valve actuator adapter 16.

The gear teeth 34 on the valve actuator adapter 16 may be configured in various patterns, including spur gear, helical gear, or bevel gear configurations, depending on the specific actuator design and torque requirements. The number of teeth may range from 10 to 60, with tooth sizes and pitch selected to optimize the balance between torque transmission and rotational speed.

The extension member 26 on the top surface 18 of the valve adapter 12 can provide a mounting surface for the actuator 14 and may have at least one actuator hole 30 that can couple to the actuator 14 to the valve adapter 12. The actuator may have at least one post configured to match to the at least one actuator hole 30 such that the at least one post can be inserted into the at least one actuator hole 30 to secure the actuator 14 to the valve adapter 12.

In the preferred embodiment, the valve adapter 12 can have four actuator holes per extension allowing the actuator to be coupled to the valve adapter at four locations. This configuration allows for the actuator 14 to be securely attached to the valve adapter 12, preventing the actuator 14 from rotating relative to the valve adapter 12, ensuring that the actuator can effectively adjust the valve settings.

Alternative mounting configurations may include threaded fasteners, snap-fit connections, magnetic attachments, or quick-release mechanisms to facilitate easy installation and removal for maintenance. The mounting system may also include vibration-dampening materials to reduce noise during operation.

In embodiments, the extension member 26 can be any suitable shape and size, and in the preferred embodiment the extension can protrude from the top surface 18 a length that allows the actuator 14, valve actuator adapter 16 and the valve stem to be coupled together. The extension member 26 may be coordinated with the actuator 14 such that the extension member 26 provides a sufficient mounting surface to stably mount the actuator 14 to the valve adapter 12.

The actuator 14 in the valve adaptor apparatus 10 can be electronically controlled which can allow for precise and accurate adjustments of the valve settings, ensuring that the valve operates as desired. The valve adapter 12 can be made from such as, for example, plastics, metals, ceramics, composites, or the like, which can provide the valve adapter with the necessary strength and durability to withstand the forces exerted by the actuator and the manual valve.

Specific suitable materials for the valve adapter 12 include, but are not limited to, high-density polyethylene (HDPE), acrylonitrile butadiene styrene (ABS), polycarbonate, polyvinyl chloride (PVC), glass-filled nylon, anodized aluminum, stainless steel (304 or 316 grade), brass, zinc alloy, and carbon fiber reinforced polymer (CFRP)

The choice of material may depend on factors including the operating environment, exposure to chemicals, temperature range, load requirements, and cost considerations. In water treatment applications, materials with NSF/ANSI 61 certification may be preferred to ensure safety for potable water systems.

The valve adapter 12 may be manufactured using various processes, including injection molding, CNC machining, die casting, 3D printing, or a combination of these methods. Different manufacturing processes may be selected based on production volume, complexity of the design, and material selection.

The valve adaptor apparatus 10 further comprises a control unit operatively connected to the actuator to facilitate adjustment of valve settings. The control unit can receive commands from an external source and transmit these commands to the actuator, allowing for the actuator to adjust the valve settings as desired.

The control unit may be integrated within the actuator housing or may be a separate component connected to the actuator via wired or wireless connections. In advanced embodiments, the control unit may include a microprocessor or microcontroller with firmware that can be updated remotely to add new features or improve performance over time.

The valve adaptor apparatus 10 can also include sensors integrated into the actuator. These sensors are configured to detect the current position of the valve. This information can be used by the control unit to determine the necessary adjustments to the valve settings. The sensors may include, but are not limited to rotary encoders to track the exact position of the valve stem, torque sensors to monitor resistance during valve operation, current sensors to detect motor load, vibration sensors to detect abnormal operation, proximity sensors to confirm proper engagement with the valve stem, temperature sensors to monitor operating conditions

In enhanced embodiments, multiple sensor types may be combined to provide redundancy and improved reliability of the system. The sensor data may be processed using algorithms that can detect patterns indicating valve wear, impending failure, or other maintenance issues.

The actuator 14 in the valve adaptor apparatus includes a motor unit. This motor unit is configured to provide the torque necessary for adjusting the valve. This ensures that the actuator has the necessary power to adjust the valve settings, even when the valve is in a closed position.

The motor unit may be a DC motor, stepper motor, or servo motor, depending on the required precision and torque specifications. Typical torque ratings may range from 15 inch-pounds to 50 inch-pounds, suitable for most residential valve applications. Higher torque versions may be available for commercial or industrial applications.

The control unit in the valve adaptor apparatus is programmed to receive commands from a smart device application. The control unit is connected through IoT communication protocols, allowing for remote control of the valve settings. This provides the user with the ability to adjust the valve settings from anywhere, at any time. Supported IoT communication protocols may include Wi-Fi (IEEE 802.11 b/g/n/ac), Bluetooth 5.0 or later, Zigbee, Z-Wave, Thread, Matter, LoRaWAN (for long-range applications)

The system may support multiple protocols simultaneously to ensure compatibility with various smart home ecosystems, including Apple Homekit, Google Home, Amazon Alexa, and others.

The valve adaptor apparatus 10 is powered by a power source from either a direct electrical connection or battery power. This provides the valve adaptor apparatus 10 with the necessary power to operate, regardless of the availability of a direct electrical connection. For direct electrical connections, the system may support various input voltages, including 110-120V AC (North America), 220-240V AC (Europe and other regions), or low-voltage options such as 12V DC or 24V DC for compatibility with existing valve control systems. Power consumption may range from 2W in standby mode to 15W during valve operation. In hybrid power configurations, the system may operate primarily on direct electrical power with automatic switching to battery backup during power outages. The system may include intelligent power management features to extend battery life, such as sleep modes, scheduled operations, and low-power wireless communications.

The valve adaptor apparatus 10 further comprises safety mechanisms configured to activate automatic water shutoff upon detection of leaks within the system. This provides an additional layer of safety, protecting the user's property from water damage.

The valve adaptor apparatus 10 can be configured to maintain a predefined state during power outages or mechanical failures. This ensures that the valve remains in a safe and controlled state, even in the event of a power outage or mechanical failure.

The failsafe configuration may be user-selectable, allowing the system to default to either an open position (maintaining water flow) or closed position (preventing potential water damage) based on the specific application and user preferences. This selection may be made during initial setup or changed later through the smart device application.

In some embodiments, the system may include a mechanical override that allows manual operation of the valve in case of complete electronic failure. This override may be designed to be easily accessible while being protected against accidental activation.

The valve adaptor apparatus is also configured to transmit notifications regarding the system's status to the user through the smart device application. This allows the user to stay informed about the status of the valve and the valve adaptor apparatus, even when they are not physically present. The notification system may be configurable to send alerts via multiple channels, including push notifications, email, SMS, or integration with third-party monitoring services.

In use, a user will remove the handle(s) on the stock valve leaving the valve stem(s) bare. The adapter apparatus 10 may be provided with the actuator 14 secured to the valve adapter 12 or with the actuator 14 and the actuator adapter 16 assembled into an assembly separate from the valve adapter 12, or with the actuator 14, the actuator adapter 16 and the valve adapter 12 provided separately to be assembled by the user.

The installation process may include a calibration routine that automatically detects the valve's full range of motion and endpoints (fully open and fully closed positions). This calibration may be performed during initial setup or may be triggered manually through the smart device application when needed.

When the actuator 14 and valve adapter 12 are assembled, the assembly is positioned such that the actuator adapter 16 in the guide hole 28 is aligned with the end of the valve stem. The actuator adapter is then pushed onto the valve stem until the end of the valve stem is securely situated within the adapter hole 32. The valve adapter 12 is shaped to allow the valve adapter 12 to be firmly mounted on the valve body.

If the valve adapter 12 and the actuator with the actuator adapter are provided separately, the valve adapter 12 may be placed firmly on the valve body with the valve stem(s) in the at least one hole 22. The actuator assembly may then be applied such that valve stem is inserted into the actuator adapter and the actuator posts are inserted into the at least one actuator hole 30.

To facilitate installation by users with limited technical expertise, the system may include color-coded components for easy identification, keyed connections that only fit together in the correct orientation, visual alignment guides, step-by-step installation instructions with accompanying mobile app guidance, or video tutorials accessible via QR codes on the packaging.

In an enhanced embodiment, the apparatus may be configured to control multiple valves simultaneously using a single control unit. This configuration may include separate actuators for each valve, all connected to a centralized control system. This approach allows for coordinated operation of multiple valves, such as those found in complex water treatment systems.

The multi-valve control system may be programmed with sequences or routines that operate multiple valves in specific orders or patterns to perform functions such as backwashing, regeneration cycles, or system bypassing. The control unit may include enhanced processing capabilities to manage these complex operations.

In another embodiment, the control system may integrate with weather forecasting services to automatically adjust valve settings based on anticipated weather conditions. For example, the system may close outdoor water lines when freezing temperatures are forecast or reduce irrigation system flow during periods of predicted rainfall. The weather-responsive features may include API connections to weather forecasting services, local temperature and humidity sensors, integration with rain sensors or soil moisture sensors or user-configurable response profiles for different weather conditions

An advanced embodiment may include flow rate sensors and control capabilities, allowing the system to not only open or close valves but also to adjust them to maintain specific flow rates. This feature would be particularly useful in irrigation systems, industrial processes, or water conservation applications. The flow control system may include integrated flow sensors, proportional control algorithms, learning capabilities to adapt to changing system conditions or user-definable flow profiles for different applications

To maximize compatibility with existing valve systems, specialized retrofitting kits may be developed for specific popular valve models. These kits would include custom-designed adapters that perfectly match the dimensions and features of particular valve models, ensuring optimal fit and function without requiring modification of the original valve. Specific kit variations might include residential water main shutoff valve kit, water softener bypass valve kit, irrigation system valve kit, pool and spa valve kit, or a hydronic heating system valve kit

A modular embodiment would allow users to start with basic functionality and add components or capabilities as needed. The base system might include just the valve automation components, with optional modules available for advanced sensor packages, extended communication range, enhanced battery backup, additional valve controls or advanced automation and scheduling capabilities.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

We claim:

1. A valve adaptor apparatus for converting to automatic operation a manual valve having a valve body and a valve stem with an end, the adaptor apparatus comprising:
a valve adapter having a top surface and a bottom surface and at least one hole extending from the top surface to the bottom surface wherein the at least one hole has a stopping member configured to engage with the valve body;
an actuator coupled to the valve adapter; and
a valve actuator adapter configured to accept the end into an adapter hole, the valve actuator adapter coupled to the actuator such that engaging the actuator rotates the valve actuator adapter and adjusts the valve settings based on external commands.

2. The valve adaptor apparatus of claim 1, wherein the at least one hole is configured to engage with at least one of the Clack V3006 valve, the, Fleck Plastic Bypass valve, and the CS-BYPASS valve.

3. The valve adaptor apparatus of claim 1, wherein the top surface has at least one extension member protruding from the top surface wherein the extension member comprises a guide hole configured to accept the valve actuator adapter.

4. The valve adaptor apparatus of claim 3, wherein the valve actuator adapter is rotatably coupled within the guide hole.

5. The valve adaptor apparatus of claim 3, wherein the extension member has at least one actuator hole that couples the actuator to the extension member.

6. The valve adaptor apparatus of claim 1, wherein the actuator is electronically controlled.

7. The valve adaptor apparatus of claim 1, wherein the valve adapter is made from material plastics and/or metals.

8. The valve adaptor apparatus of claim 1, further comprising a control unit operatively connected to the actuator to control adjustment of valve settings.

9. The valve adaptor apparatus of claim 1, further comprising sensors integrated into the actuator and configured to detect the current position of the valve.

10. The valve adaptor apparatus of claim 1, further comprising a motor unit within the actuator configured to provide torque necessary for adjusting the valve.

11. The valve adaptor apparatus of claim 1, wherein the control unit is programmed to receive commands from a smart device application and is connected through IoT communication protocols.

12. The valve adaptor apparatus of claim 1, wherein the adapter is powered by a power source from either a direct electrical connection or battery power.

13. The valve adaptor apparatus of claim 1, further comprising safety mechanisms configured to activate automatic water shutoff upon detection of leaks within the system.

14. The valve adaptor apparatus of claim 1, configured to maintain a predefined state during power outages or mechanical failures and to transmit notifications regarding the system's status to the user through the smart device application.
